(19) United States
(12) Patent Application Publication
(10) Pub. No.: US 2011/0140589 A1
(43) Pub. Date: Jun. 16, 2011

(54) LED LAMP CONFIGURED TO PROJECT A SUBSTANTIALLY HOMEGENOUS LIGHT PATTERN

(75) Inventor: Muessli Daniel, Biel (CH)

(73) Assignee: FUTUR-TEC (HONG KONG) LIMITED, Hong Kong (CN)

(21) Appl. No.: 12/968,560

(22) Filed: Dec. 15, 2010

Related U.S. Application Data
(60) Provisional application No. 61/286,392, filed on Dec. 15, 2009.
(60) Provisional application No. 61/286,806, filed on Dec. 16, 2009.

(51) Int. Cl. H01K 1/30

(52) U.S. Cl. 313/110

(57) ABSTRACT

A light emitting diode (LED) lamp is provided herein. The LED lamp comprises an LED support configured to dispose an array of LEDs. The array of LEDs are disposed on the LED support wherein each LED is disposed substantially equidistantly about a circumference of the LED support and each LED is disposed substantially equidistantly from an outer periphery of the LED lamp. A lens is in light communication with the array of LEDs and is configured and disposed to refract a substantial portion of light emitted from the array of LEDs into a substantially homogenous pattern onto a surface to be illuminated.

### CROSS-REFERENCE TO RELATED APPLICATIONS

This application claims the benefit of U.S. Provisional Application No. 61/286,392, filed Dec. 15, 2009 and U.S. Provisional Application No. 61/286,806, filed Dec. 16, 2009.

### FIELD OF THE DISCLOSURE

This disclosure relates generally to lamps, and more particularly, to a light emitting diode (LED) lamp comprising an array of LEDs disposed therein and configured to provide a substantially homogenous light pattern on a surface to be illuminated.

### BACKGROUND

Background information is for informational purposes only and does not necessarily admit that subsequently mentioned information and publications are prior art.

Incandescent light bulbs have been and are currently used in a large variety of lighting products. An incandescent light bulb or lamp produces light by heating a metal filament wire to a high temperature until it glows. The hot filament is protected from air by a glass bulb that is filled with inert gas or evacuated. Most lamps are configured to be used in a socket and comprise a base, such as an Edison screw base, an MR16 shape with a bi-pin base, or a GU5.3 (Bipin cap) or GU10 (bayonet socket).

Even though incandescent light bulbs are relatively inexpensive, as compared to alternative light sources, incandescent light bulbs have several drawbacks. For example, incandescent light bulbs use a relatively large amount of power compared to other lighting products which increase energy costs. Also, incandescent light bulbs have a relatively short life causing repetitive replacement costs.

Recently, fluorescent lamps, particularly compact fluorescent lamps (CFLs), have been developed to overcome some of the drawbacks associated with the incandescent lamps. For example, fluorescent lamps are more efficient and have a longer life than incandescent lamps. A fluorescent lamp is a gas-discharge lamp that uses electricity to excite mercury vapor. The excited mercury atoms produce short-wave ultraviolet light that then causes a phosphor to fluoresce, producing visible light. Fluorescent lamps convert electrical power into useful light more efficiently than incandescent lamps, lowering energy costs. Larger fluorescent lamps are mostly used in commercial or institutional buildings and CFLs have been developed to be used in the similar manner as incandescent. Even though fluorescent lamps have overcome some of the drawbacks associated with the incandescent lamps, drawbacks remain. For example, fluorescent lamps contain mercury which is hazardous to human health and they may have a delayed response time when turning on the lamp.

More recently, light emitting diode (LED) lamps have been developed to overcome some of the drawbacks associated with the incandescent and fluorescent lamp. An LED lamp is a solid-state lamp that uses LEDs as the source of light. An LED may comprise a conventional semiconductor light emitting diode or an organic or polymeric light emitting diode. The light emitted by an LED is caused by the generation of photons from materials within the LED and is not the product of an electrical current passing through an illuminating filament. LED lamps may have one or more advantages over fluorescent lamps, for example, LED lamps do not contain mercury, they may turn on instantly, they may have a longer service life, they may have a smaller size, and they may have a greater efficiency.

However, currently available LED lamps may not be well suited for some lighting applications. For example, LED lamps may require a plurality of LEDs to provide a desired amount of light generation. A plurality of LEDs may generate a non-homogenous light pattern which may be undesirable. Additionally, LED lamps may require heat management systems to dissipate heat generated by the LEDs. Furthermore, LED lamps may require circuitry to rectify the AC power and to convert the voltage to a level usable by the LEDs. Such requirements may introduce obstacles in designing LED lamps, LED luminaires, and LED lamps that may be interchangeable with other types of lamps currently used in a variety of luminaires.

What is needed is an LED lamp that overcomes some of the obstacles associated with current LED lamps and provides a desirable light intensity and light pattern.

### SUMMARY

In one aspect of the present disclosure, an LED lamp comprises an LED support, such as one or more printed circuit boards (PCBs), metal core printed circuit boards (MCPCBs), chip on boards (COBs), heat sinks, or other LED supports known in the art, configured to dispose an array of LEDs, an array of LEDs disposed on the LED support wherein each of the LEDs are disposed substantially equidistantly about a periphery of the LED support and each of the LEDs are disposed substantially equidistantly from an outer periphery of the LED lamp, a lens in light communication with the array of LEDs, and the lens is configured and disposed to refract a substantial portion of light emitted from the array of LEDs into a substantially homogenous pattern onto a surface to be illuminated.

In another aspect of the present disclosure, an LED lamp is provided, the LED lamp comprises an array of LEDs disposed on a circular LED support, each LED is circumferentially spaced from adjacent LEDs by a substantially equal distance, a lens is disposed in light communication with the array of LEDs, and the lens is configured and disposed to project a substantially homogenous light pattern from the array of LEDs.

In a further aspect of the present disclosure, an LED lamp comprises an array of LEDs uniformly spaced about a circumference thereof and a lens is disposed in light communication with the array of LEDs, the array of LEDs and the lens are configured and disposed to project a substantially homogenous light pattern from the LED lamp.

### BRIEF DESCRIPTIONS OF THE DRAWINGS

The following figures, which are idealized, are not to scale and are intended to be merely illustrative of aspects of the present disclosure and non-limiting. In the drawings, like elements are depicted by like reference numerals. The drawings are briefly described as follows.

FIG. 1 is a perspective view of an LED lamp showing the disposition of a lens with respect to other components of the LED lamp;

FIG. 2A is a perspective view of the lens of FIG. 1 showing a plurality of collimators in light communication with an array of LEDs;

FIG. 2B is a cross-sectional view of the lens of FIG. 1 showing the disposition of the collimators with respect to the array of LEDs;

FIG. 2C is a cut-away cross-sectional view of the lens of FIG. 1 showing the light communication between a collimator and an LED and the component parts thereof;

FIG. 3A is a cut-away perspective view of an LED lamp showing the disposition of a lens comprising a sole collimator with respect to other components of the LED lamp;

FIG. 3B is a cross-sectional view of the lens shown in FIG. 3A showing the disposition of the sole collimator with respect to an array of LEDs;

FIG. 4A is a perspective view of the lens of FIG. 3A and an LED showing the light communication between the sole collimator and the LED and the refraction of light with the sole collimator;

FIG. 4B is a perspective view of the lens of FIG. 3A and an LED showing the light pattern generated with the disposition and configuration of the LED and sole collimator; and

FIG. 4C shows a substantially homogenous light pattern generated with the sole collimator shown in FIG. 3A.

### DETAILED DESCRIPTION

Reference will now be made in detail to the present exemplary embodiments and aspects of the present invention, examples of which are illustrated in the accompanying figures. Wherever possible, the same reference numbers will be used throughout the figures to refer to the same or like parts.

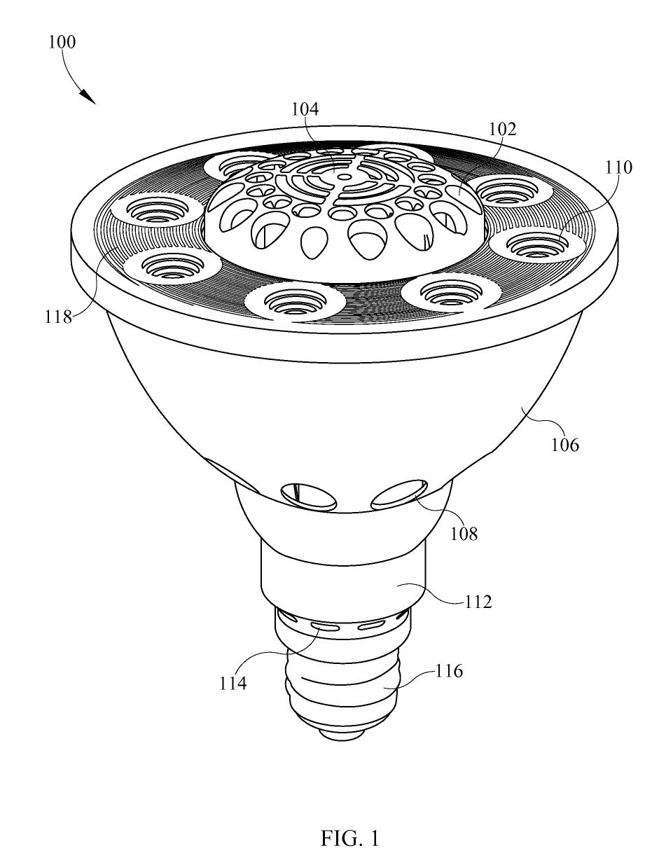

FIG. 1 shows LED lamp 100. Lamp 110 comprises a connector 116 configured to connect LED lamp 100 to existing lamp sockets. Connector 116 may be an Edison screw base, as shown, a bi-pin base, a bayonet, or other connector configured to connect lamp 100 to a lamp socket. Lower housing 112 extends from base 116 and may comprise vent holes 114. Upper housing 106 extends from lower housing 112 and may comprise vent holes 108. Upper housing 106 and lower housing 112 may be unitary and may be configured to provide a parabolic lamp 100 as shown or may have other configurations as are known in the art.

Lens 118 is disposed on the open end of upper housing 106. Lens 118 is disposed in light communication with an array of LEDs, disposed in upper housing 106, and is configured to refract a substantial portion of light emitted from the array of LEDs into a substantially homogenous pattern onto a surface to be illuminated. Lens 118 comprises an array of collimators 110, each disposed substantially equidistantly about lens 118 and substantially equidistantly from an outer periphery of LED lamp 100. Lens 118 may be comprised solely of a light transmissible material such as glass or polymeric materials. Lens 118 may comprise ridges or other light scattering pattern between each collimator 110 as shown or may have a smooth outer surface.

Lens 118 is disposed about cap 104. Cap 104 may comprise one or more vents 102. Vents 102 may be in flow communication with vents 114 and/or vents 108. In at least one embodiment, vents 104 are in flow communication with vents 114 and provide air cooling to circuitry in lower housing 112 wherein the circuitry may be configured to rectify AC power and convert voltage. In at least one other embodiment, vents 102 are in flow communication with vents 108 and provide air cooling to the array of LEDs disposed in upper housing 106. Cooling air may pass through vents 102, 108, and/or 114 by natural convection or by forced air.

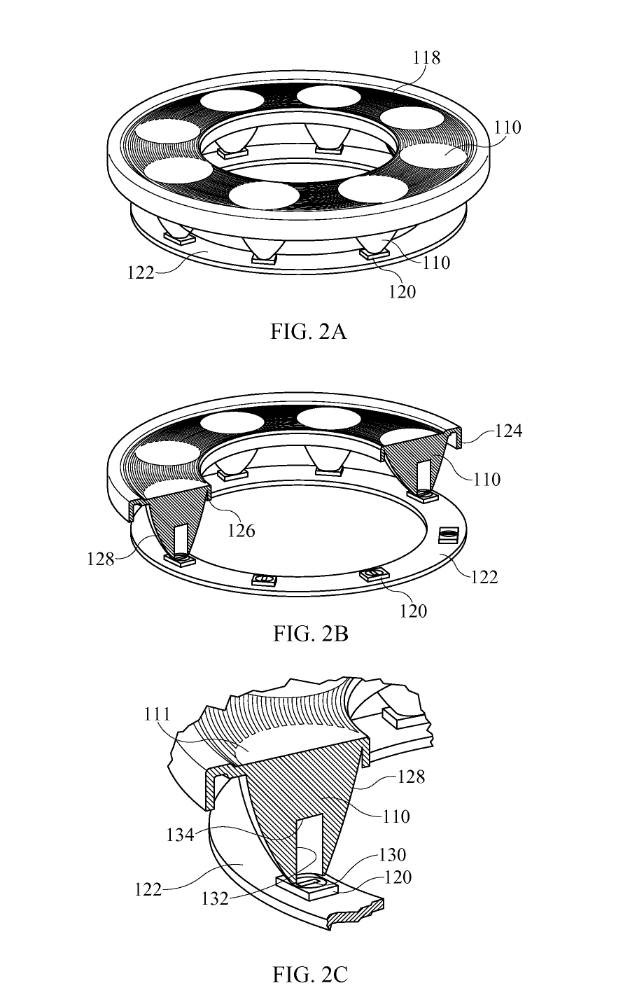

FIGS. 2A-2C show lens 118 in light communication with an array of LEDs 120. LED support 122 has a ring or circular configuration with an open central portion configured to allow air to pass through vents 102. LED support 122 may comprise one or more PCBs, MCPCBs, COBs, heat sinks, or other LED supports as are known in the art. LED support 122 may be comprised of maetallic materials, organic materials, ceramic materials, inorganic materials, or other materials as are known in the art, and combinations thereof. LED support 122 is configured to dispose an array of LEDs 120 substantially equidistantly from an outer periphery of LED support 122 and substantially equidistantly from an outer periphery of LED lamp 100. Each LED 120 is disposed on LED support 122 so that each LED 120 is circumferentially spaced from adjacent LEDs 120 by a substantially equal distance to be in light communication with an individual collimator 110.

Lens 118 may be unitary and is disposed in light communication with the array of LEDs 120. Lens 118 is configured and disposed to refract a substantial portion of light emitted from the array of LEDs 120 into a substantially homogenous pattern onto a surface to be illuminated. In the aspect shown, Lens 118 has an inner flange 126 configured and disposed to cooperate with an outer portion of cap 104. Lens 118 also has outer flange 124 configured and disposed to cooperate with an end portion upper housing 106. Lens 118 comprises an individual collimator 110 in light communication with each LED 120.

A single collimator 110 is disposed to be in light communication with each LED 120. Lens 118 may be unitary with each collimator 110, inner collimator flange 126, and/or outer collimator flange 124. Each said sole collimator 110 is configured and disposed to project a circular light pattern from an LED 120 wherein each projected circular light pattern overlaps each other circular light pattern by an amount sufficient to produce a substantially homogenous circular light pattern having a higher light intensity at its center.

Each individual collimator 110 comprises a planar light projecting surface 111 with a substantially frustoconical sidewall 128 extending to a light gathering end, proximate each LED 120. Substantially frustoconical sidewall 128 may be convex as shown in FIGS. 2A and 2B. The light gathering end of each collimator 110 comprises an inner cylindrical sidewall 132 extending axially into each individual collimator 110. Light projecting surface 111 has a radius greater than a radius of inner cylindrical sidewall 132. Inner cylindrical sidewall 132 terminates with inner circular end wall 134. Inner circular end wall 134 may be planar, convex, or concave.

An LED 120 is disposed with LED support 122 proximate each light gathering end or inner cylindrical sidewall 132 of a collimator 110. LED 120 has a longitudinally extending light emitting portion 130 radially aligned with LED lamp 100. However, it is to be understood that a circumferential alignment, or other alignment, of light emitting portion 130 may provide desirable patterns of light projected from lamp 100 and are within the scope of the present disclosure.

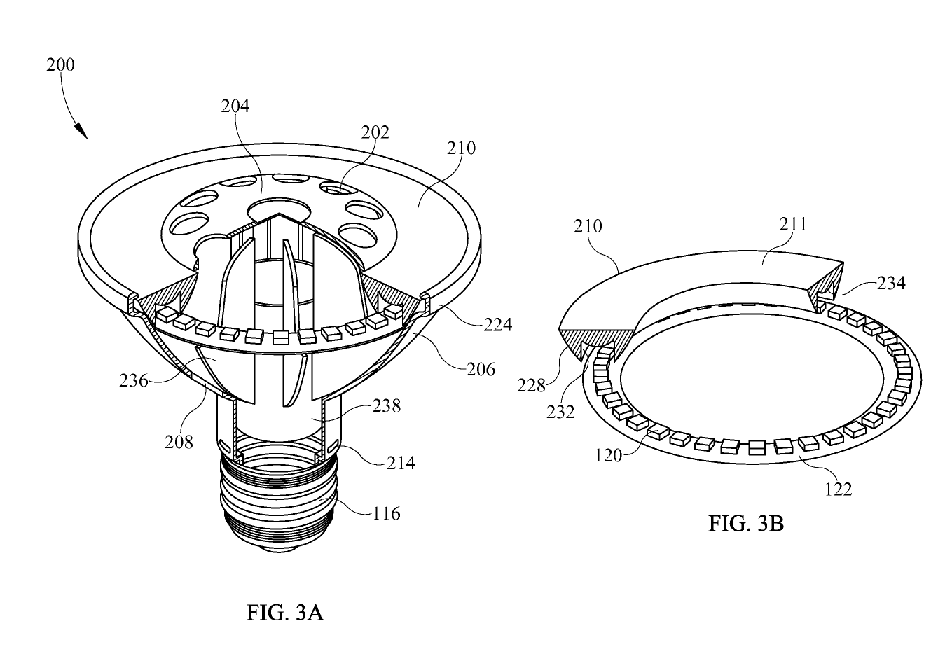

FIG. 3A shows LED lamp 200 and the disposition of lens 210 with respect LEDs 120 and other internal components. Lens 210 comprises a sole collimator having a circular or ring configuration with a substantially uniform cross-sectional area throughout its circumference. Cap 204 is configured and disposed to substantially cover the inner void region of lens 210. Cap 204 comprises a plurality of vent holes 202. It is to be understood that vent holes 202 may have a variety of configurations and arrangements providing passage of air therethrough. Extending from an outer periphery of lens 210 is housing 206. Housing 206 has outer flange 224 configured and disposed to cooperate with an outer edge of lens 210. Housing 206 has a parabolic configuration but may have a variety of configurations as are known in the art.

Vent holes 208 are disposed in an upper portion of housing 206 and are in flow communication with vent holes 202 in cap 204. A flow of air, forced air or natural convection, through vent holes 208 and 202 provides a flow of air about LEDs 120 and through the inner void region of lens 210. Optionally, cooling fins 236 are disposed in housing 206 and configured to aid in the transfer of heat from LEDs 122 to air flowing through lamp 200. Housing 206 may also have vent holes 214 proximate connector 116 configured and disposed to increase the volume of air flowing through portions of lamp 200. In an aspect of the present disclosure where circuitry is disposed in base 116 or in housing 206 proximate base 116, vent holes 214 may provide for the flow through of air to cool the circuitry. Cylinder 238 may be disposed with housing 206 and may be configured to provide structural support for component parts of lamp 200 and may also be configured to control the flow of air through lamp 210.

Shown in FIG. 3B is an array of LEDs 120 disposed with LED support 122 to be in light communication with lens 210. An array of LEDs 120 are disposed on circular or ring shaped LED support 122 wherein each LED 120 is disposed substantially equidistantly or uniformly spaced from each other and about a periphery of LED support 122. Lens 210 is disposed to be in light communication with the array of LEDs 120 and comprises a sole collimator having a circular configuration with a substantially uniform cross-section. Lens 210 is configured and disposed to refract a substantial portion of light emitted from the array of LEDs 120 into a substantially homogenous pattern onto a surface to be illuminated.

Lens 210 comprises a light projecting surface 211 configured to project light. In the aspect shown here, light projecting surface 211 is planar, however it is to be understood that light projecting surface 211 may be convex, concave, or have other configurations for projecting a substantially homogeneous light pattern. The configuration of light projecting surface 211 may be contingent upon the configuration of a light gathering surface.

Inner and outer collimator sidewalls 228 extend from inner and outer edges of light projecting surface 211 toward the array of LEDs 120. Sidewalls 228 are tapered inwardly from light projecting surface 211 toward the array of LEDs 120. Sidewalls 228 may be convex as shown or may be planar. Sidewalls 228 extend from light projecting surface 211 to a light gathering surface comprising a trough having inner cylindrical sidewalls 232 and inner end wall 234. Inner cylindrical sidewalls 232 are disposed around lens 210 between inner and outer sidewalls 228 and extend toward light projecting surface 211. Inner cylindrical sidewalls 232 terminate at inner end wall 234. Inner cylindrical sidewalls 232 and end wall 234 are configured to gather light emitted from the array of LEDs 120. Inner end wall 234 may be convex as shown or may have other configurations which may depend on a configuration of light projecting surface 211 to provide a substantially homogenous pattern of light.

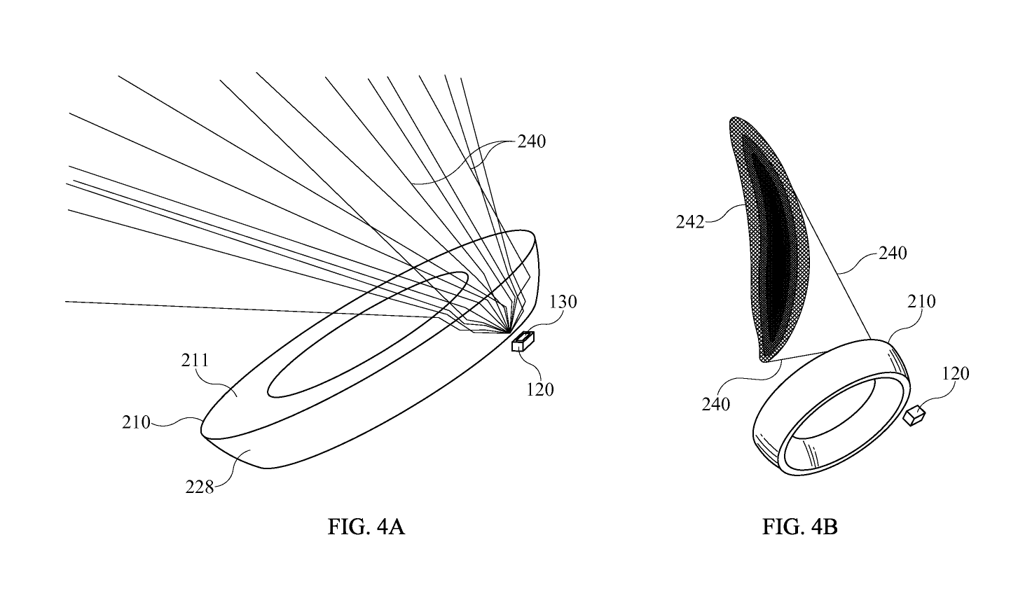

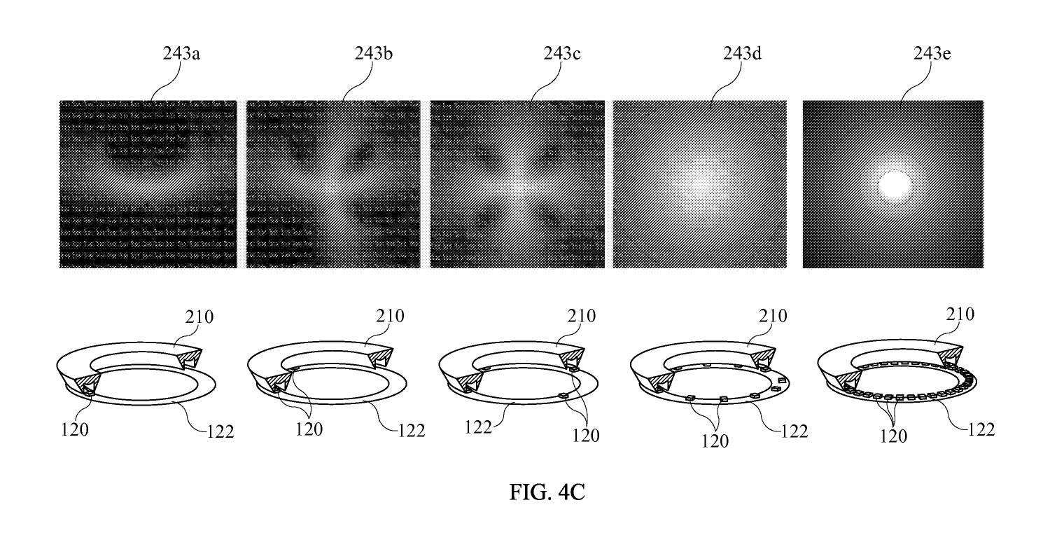

FIGS. 4A and 4B show an aspect of the present disclosure wherein lens 210 and each LED 120 are configured and disposed to project an arc pattern of light. Led 120 is disposed to have a longitudinally extending light emitting portion 130 disposed tangentially with a circumference of lens 210. Light is emitted with LED 120 and gathered with the light gathering surface of lens 210. Light rays 240 are shown to be refracted within lens 210 and refracted with collimator sidewalls 228 or otherwise directed to exit light projecting surface 211. FIG. 4B shows arc pattern 242 on a surface illuminated with LED 120 and lens 210. Arc pattern 242 has a greater light intensity proximate its center as shown with darker shading and a lesser intensity about its periphery as shown with lighter shading.

FIG. 4C shows an array of LEDs producing a substantially homogenous light pattern on an illuminated surface with each individual LED producing an arc pattern. In this aspect, lens 210 comprises a sole collimator and each LED is disposed to project an arc pattern from lens 210 as shown in light pattern 243a. Light pattern 243b shows the overlapping of arc patterns when two LEDs 120 are disposed on LED support 122 at approximately 90° from each other as shown in the configuration depicted below light pattern 243b. Light pattern 243c shows the overlapping of arc patterns when four LEDs 120 are disposed on LED support 122 at approximately 90° from each other as shown in the configuration depicted below light pattern 243c. Light patterns 243d and 243e shows the overlapping of arc patterns when an array LEDs 120 are disposed on LED support 122 at substantially equal distances from each other as shown in the configuration depicted below light patterns 243d and 243e. It is shown with this aspect of the present disclosure that a substantially homogeneous light pattern may be provided with an array of LEDs comprising approximately eight or more LEDs. For example, it is shown that four LEDs 120 disposed at approximately 90° projects an “X” pattern 243c and therefore the disposition of eight LEDs at approximately 45° from each other will produce an overlying “X” pattern filling in darker areas of light pattern 243c to provide a substantially homogenous light pattern. Additional LEDs in an array of LEDs may provide greater illumination of a surface as shown in light patterns 243d and 243e. However, it is to be understood that the number of LEDs in an array of LEDs required to generate a substantially homogeneous light pattern may be contingent on a number of factors such as the configuration of collimator(s), orientation of the LEDs, radius of the LED support or lamp, intensity and pattern of light generated with each LED, and the distance between the array of LEDs and collimator(s). Therefore, the number of LEDs in an array of LEDs is not a limitation of the present disclosure.

Aspects of the present disclosure provide LED lamps that may be retrofitted into existing luminaires. Other aspects of the present disclosure may also provide complete LED fixtures, fixture modules, luminaires, illuminates, or other lighting apparatuses. For example, aspects of the present disclosure may comprise non replaceable LED lamp(s) permanently mounted in a luminaire or other lighting apparatus. In this aspect, the LED lamp(s) may comprise a standard connector or industry standard base configuration or the LED lamp(s) may be a non removable part of the lighting apparatus and may not comprise an industry standard base configuration.

Some examples of LEDs that may possibly be utilized or adapted for use in at least one possible embodiment may possibly be found in the following U.S. patents: U.S. Pat. No. 5,739,552, entitled “Semiconductor light emitting diode producing visible light”; U.S. Pat. No. 5,923,052, entitled “Light emitting diode”; U.S. Pat. No. 6,045,930, entitled “Materials for multicolor light emitting diodes”; U.S. Pat. No. 6,329,085, entitled “Red-emitting organic light emitting devices (OLED's)”; U.S. Pat. No. 6,869,813, entitled “Chip-type LED and process of manufacturing the same”; U.S. Pat. No. 6,967,117, entitled “Method for producing high brightness LED”; U.S. Pat. No. 7,229,571, entitled “Phosphor for white LED and a white LED”; U.S. Pat. No. 7,285,802, entitled “Illumination assembly and method of making same”; U.S. Pat. No. 7,402,831, entitled “Adapting short-wavelength LED's for polychromatic, broadband, or “white” emission”; and U.S. Pat. No. 7,838,317, entitled “Vertical nitride semiconductor light emitting diode and method of manufacturing the same”.

Some examples of LED supports that may possibly be utilized or adapted for use in at least one possible embodiment may possibly be found in the following U.S. patents: U.S. Pat. No. 7,674,987, entitled “Multilayer printed circuit board”; U.S. Pat. No. 6,903,938, entitled “Printed circuit board”; U.S. Pat. No. 5,466,174, entitled “Apparatus to connect LEDs at display panel to circuit board”; U.S. Pat. No. 7,432,450, entitled “Printed circuit board”, and U.S. Pat. No. 6,317,330, entitled “Printed circuit board assembly”.

Some examples of collimators that may possibly be utilized or adapted for use in at least one possible embodiment may possibly be found in the following U.S. patents and patent publications: U.S. Pat. No. 6,547,423, entitled “LED collimation optics with improved performance and reduced size”; U.S. Pat. No. 6,654,175, entitled “Integrated LED/photodiode collimator array”; U.S. Pat. No. 6,927,919, entitled “Collimating lens, collimating system, and image displaying apparatus using collimating system”; U.S. Pat. No. 7,370,994, entitled “Collimating lens for LED lamp”; U.S. Pat. No. 7,526,162, entitled “Collimator”; U.S. Pat. No. 7,580,192, entitled “Collimation lens system for LED”; and U.S. Pat. Pub. No. 20070159847, entitled “Collimating lens for LED lamp”.

Some examples of circuitry that may possibly be utilized or adapted for use in at least one possible embodiment may possibly be found in the following U.S. patents and patent publications: U.S. Pat. No. 6,227,679, entitled “Led light bulb”; U.S. Pat. Pub. No. 20090289267, entitled “Solid state led bridge rectifier light engine”; U.S. Pat. No. 7,679,292, entitled “LED lights with matched AC voltage using rectified circuitry”; U.S. Pat. No. 6,359,392, entitled “High efficiency LED driver”; U.S. Pat. Pub. No. 20100084990, entitled “Dimmable LED lamp”; U.S. Pat. Pub. No. 20070069663, entitled “Solid state LED bridge rectifier light engine”; and U.S. Pat. No. 6,570,505, entitled “LED lamp with a fault-indicating impedance-changing circuit”.

The patents, patent applications, and patent publication listed above in the preceding 4 paragraphs are herein incorporated by reference as if set forth in their entirety. The purpose of incorporating U.S. patents is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The invention is illustrated by example in the drawing figures, and throughout the written description. It should be understood that numerous variations are possible while adhering to the inventive concept. Such variations are contemplated as being a part of the present disclosure.

### LIST OF NOMENCLATURE

100 LED lamp with individual collimators
102 vent
104 cap
106 upper housing
108 vent
110 individual collimator
111 light projecting surface
112 lower housing
114 vent
116 connector
118 lens
120 LED
122 LED support
124 outer collimator flange
126 inner collimator flange
128 outer collimator wall
130 light emitting portion, LED
132 inner cylindrical side wall
134 inner circular end wall
200 LED lamp with individual collimators
202 vent
204 cap
206 housing
208 vent
210 collimator
211 light projecting surface
214 vent
224 outer flange, housing
228 collimator sidewalls
232 inner cylindrical side wall
234 inner end wall
236 cooling fin
238 cylinder
240 light rays
242 light pattern
243a-243e light patterns

1. A light emitting diode (LED) lamp, comprising:
an LED support configured to dispose an array of LEDs;
an array of LEDs disposed on said LED support wherein each said LED is disposed substantially equidistantly about a circumference of said LED support and each said LED is disposed substantially equidistantly from an outer periphery of said LED lamp;
a lens in light communication with said array of LEDs; and
said lens being configured and disposed to refract a substantial portion of light emitted from said array of LEDs into a substantially homogenous pattern onto a surface to be illuminated.

2. The LED lamp of claim 1 wherein said lens comprises an individual collimator in light communication with each said LED.

3. The LED lamp of claim 2 wherein each said individual collimator comprises:
a substantially frustoconical sidewall having a first end of a first radius and a second end of a second radius;
said first radius being greater than said second radius;
a planar wall configured to project light disposed on said first end of said sidewall;
a wall configured to gather light disposed on said second end of said sidewall; and
said wall configured to gather light comprises a cylindrical portion extending axially into said individual collimator.

4. The LED lamp of claim 3 wherein said substantially frustoconical sidewall is convex.

5. The LED lamp of claim 4 wherein each said LED has a longitudinally extending light emitting portion radially aligned with said LED lamp.

6. The LED lamp of claim 1 wherein said lens comprises a sole collimator having a circular configuration with a substantially uniform cross-sectional area about its circumference.

7. The LED lamp of claim 6 wherein said sole collimator comprises:
a planar wall configured to project light;
a first sidewall extending from an inner edge of said planar wall toward said array of LEDs;
a second sidewall extending from an outer edge of said planar wall toward said array of LEDs;
said inner sidewall and said outer sidewall being tapered inwardly toward said array of LEDs;
a trough configured to gather light disposed around said sole collimator between said inner and outer sidewalls and extending toward said planar wall;
said trough comprising an inner side surface cylindrically extending from said inner sidewall to an end surface, said end surface being disposed proximate said planar wall; and
said trough comprising an outer side surface cylindrically extending from said outer sidewall to said end surface.

8. The LED lamp of claim 7 wherein said first and said second sidewalls are convex.

9. The LED lamp of claim 7 wherein said first end surface of said trough is convex.

10. An LED lamp comprising:
an array of LEDs disposed on a circular LED support;
each said LED being circumferentially spaced from adjacent LEDs by a substantially equal distance;
a lens disposed in light communication with said array of LEDs; and
said lens being configured and disposed to project a substantially homogenous light pattern from said array of LEDs.

11. The LED lamp of claim 10 wherein said lens comprises an individual collimator disposed to be in light communication with each said LED, each said individual collimator being configured and disposed to project a circular light pattern from said lens, each said LED and each said sole collimator being disposed to overlap each circular light pattern by an amount sufficient to produce a substantially homogenous circular light pattern having a higher light intensity at its center.

12. The LED lamp of claim 11 wherein said lens and each said individual collimator are unitary.

13. The LED lamp of claim 10 wherein said lens comprises a sole collimator in light communication with said array of LEDs, said sole collimator being configured and disposed to project an arc light pattern of light from each said LED, each said LED and said sole collimator being disposed to overlap each arc light pattern by an amount sufficient to produce a substantially homogenous circular light pattern having a higher light intensity at its center.

14. The LED lamp of claim 13 wherein said sole collimator comprises a ring with a substantially consistent cross-sectional area throughout its circumference.

15. The LED lamp of claim 10 further comprising:
a parabolic housing extending from an outer peripheral edge of said lens to a lamp connector;
a cap covering a void inner area of said lens;
said housing comprising a plurality of vent holes; and
said cap comprising a plurality of vent holes in flow communication with said plurality of vent holes in said housing.

16. An LED lamp comprising an array of LEDs uniformly spaced about a circumference thereof and a lens disposed in light communication with said array of LEDs, said array of LEDs and said lens being configured and disposed to project a substantially homogenous light pattern from said LED lamp.

17. The LED lamp of claim 16 wherein said lens and each said LED are configured and disposed to project an overlapping arc pattern of light from each said LED.

18. The LED lamp of claim 17 wherein said lens comprises a collimator extending thereabout and each said LED comprises a longitudinally extending light emitting portion disposed tangentially with a circumference of said collimator.

19. The LED lamp of claim 16 wherein said lens and each said LED are configured and disposed to project an overlapping circular pattern of light from each said LED.

20. The LED lamp of claim 19 wherein said lens comprises a plurality of collimators, each said collimator being disposed to be in light communication with one of said LEDs, and each said LED comprises a longitudinally extending light emitting portion disposed radially with said LED lamp.
